(19) United States
(12) Patent Application Publication
(10) Pub. No.: US 2024/0296163 A1
(43) Pub. Date: Sep. 5, 2024

(54) DATA PROCESSING METHODS, DEVICES AND NON-TRANSITORY STORAGE MEDIUMS

(71) Applicants: Beijing Zhongxiangying Technology Co., Ltd., Beijing (CN); BOE TECHNOLOGY GROUP CO., LTD., Beijing (CN)

(72) Inventors: Fan ZHANG, Beijing (CN); Haijin WANG, Beijing (CN); Hong WANG, Beijing (CN); Yiming LEI, Beijing (CN); Dong CHAI, Beijing (CN); Wangqiang HE, Beijing (CN); Jianmin WU, Beijing (CN)

(21) Appl. No.: 17/800,304

(22) PCT Filed: May 31, 2021
(86) PCT No.: PCT/CN2021/097393

§ 371 Date: Aug. 17, 2022

(51) Int. Cl. G06F 16/2457; G06F 16/242

(52) U.S. Cl. CPC G06F 16/24578; G06F 16/2428

(57) ABSTRACT

A data processing method includes: acquiring sample data of each sample of samples produced within a preset time period, the sample data including a value, which is acquired at each acquisition time, of a device parameter of a device through which the sample passes, and a test result of the sample; dividing sample data of the samples into data of positive samples and data of negative samples according to test results of the samples; determining a sample segment point of each sample according to values of the device parameter, so as to obtain N value groups of target values corresponding to each sample; and determining a related quantized value according to a difference between an M-th value group of a positive sample and an M-th value group of a negative sample.

### CROSS-REFERENCE TO RELATED APPLICATION

This application is a national phase entry under 35 USC 371 of International Patent Application No. PCT/CN2021/097393, filed on May 31, 2021, which is incorporated herein by reference in its entirety.

### TECHNICAL FIELD

The present disclosure relates to the field of data processing technologies, and in particular, to data processing methods, devices and non-transitory storage mediums.

### BACKGROUND

In the manufacturing process of products, devices involved in process steps through which raw materials of a product pass and device parameters corresponding to the devices will affect performance of the product, and may cause substandard performance (also referred to as defect) of the product. Therefore, for the product with substandard performance, there is a need to find out the cause of the substandard performance of the product according to devices and device parameters.

### SUMMARY

In an aspect, a data processing method is provided. The method includes: acquiring sample data of each sample of a plurality of samples produced within a preset time period, the sample data including a value, which is acquired at each acquisition time, of a device parameter of the device through which the sample passes, and a test result of the sample; dividing sample data of the plurality of samples into data of positive samples and data of negative samples according to test results of the plurality of samples; determining a sample segment point of each sample according to values of the device parameter, so as to obtain N value groups of target values corresponding to each sample, the sample segment point of each sample being used to represent an abrupt change point of the values of the device parameter of each sample, and the target values including values, a time difference between adjacent two acquisition times of which is less than a first threshold, in the values of the device parameter, and N being a positive integer greater than or equal to 1; and determining a related quantized value according to a difference between an M-th value group of a positive sample and an M-th value group of a negative sample, the related quantized value being used to represent a degree of influence of the device parameter on a defective sample, and M being a positive integer less than or equal to N.

In some embodiments, determining the related quantized value according to the difference between the M-th value group of the positive sample and the M-th value group of the negative sample includes: determining a first value of statistical indices of the M-th value group of the negative sample and a second value of statistical indices of the M-th value group of the positive sample, statistical indices of each value group being used to represent a centralized trend or a variation trend of values in the value group; determining a difference between the first value and the second value; and determining the related quantized value according to the difference between the first value and the second value.

In some other embodiments, determining the difference between the first value and the second value includes: determining the difference between the first value and the second value according to a feature parameter of a plurality of first values of the negative sample and a feature parameter of a plurality of second values of the positive sample.

In yet some other embodiments, the feature parameter includes a value at a target position, or a population mean, or the value at the target position and the population mean value.

In yet some other embodiments, determining the difference between the first value and the second value according to the feature parameter of the plurality of first values of the negative sample and the feature parameter of the plurality of second values of the positive sample includes: determining a first difference between a value at a target position in the plurality of first values of the negative sample and a value at the target position in the plurality of second values of the positive sample; determining a second difference between a population mean value of the plurality of first values of the negative sample and a population mean value of the plurality of second values of the positive sample; and determining the difference between the first value and the second value according to the first difference, the second difference and a preset weight.

In yet some other embodiments, determining the sample segment point of each sample according to the values of the device parameter, so as to obtain the N value groups of the target values corresponding to each sample includes: determining sample data of a reference sample according to the values of the device parameter, the reference sample being a sample in the positive samples; determining a signal-to-noise ratio of the reference sample, an absolute value of the signal-to-noise ratio being a signal-to-noise ratio absolute value; taking a value, an absolute value of which is greater than the signal-to-noise ratio absolute value, in filtered values of the device parameter, as a reference sample segment point; and determining the sample segment point of each sample according to a reference ratio and the reference sample segment point, so as to obtain the N value groups of the target values corresponding to each sample, the reference ratio being a ratio of a number of values of the device parameter of the reference sample to a number of the values of the device parameter of each sample.

In yet some other embodiments, determining the sample segment point of each sample according to the reference ratio and the reference sample segment point includes: determining an initial sample segment point of each sample according to the reference ratio and the reference sample segment point; acquiring, according to the determined initial sample segment point and a size of a preset window, a correlation between value groups of the device parameter, in which one value group is at a distance within a size range of the preset window from the initial sample segment point, and another value group is at a distance within the size range of the preset window from the reference sample segment point; and correcting the initial sample segment point of each sample according to the correlation.

In yet some other embodiments, determining the sample data of the reference sample according to the values of the device parameter includes: performing Fourier transform on values of the device parameter of each of the positive samples; taking a minimum number of transformed values of the device parameter of the positive samples as a trimming number; acquiring front values, a number of which is the trimming number, in the values of the device parameter of each of the positive samples, so as to obtain a plurality of trimming value groups, a number of values included in each trimming value group being the trimming number; acquiring, according to an order of the values in each trimming value group, a median of values at each position in the plurality of trimming value groups, so as to obtain a median sequence; and determining the sample data of the reference sample in the data of the positive samples, the reference sample being a sample with a minimum difference value with the median sequence in the positive samples.

In yet some other embodiments, acquiring the sample data of each sample of the plurality of samples produced within the preset time period includes: acquiring initial sample data of each sample produced within the preset time period; acquiring numbers of target values of the positive samples in initial sample data of the plurality of samples; determining a value range according to the numbers of the target values of the positive samples; and filtering initial data of a positive sample, a number of target values of which is outside the value range, in the initial sample data of the plurality of samples produced within the preset time period, so as to obtain the sample data of each sample of the plurality of samples produced within the preset time period.

In yet some other embodiments, acquiring the sample data of each sample of the plurality of samples produced within the preset time period includes: acquiring the initial sample data of each sample produced within the preset time period; determining a trimming length according to at least a median of numbers of target values of the initial sample data of the plurality of samples; and trimming the acquired initial sample data of each sample according to the trimming length, so as to obtain the sample data of each sample of the plurality of samples produced within the preset time period.

In yet some other embodiments, the method further includes: sorting related quantized values according to magnitudes thereof, and outputting a sorting of value groups of the device parameter corresponding to the related quantized values.

In yet some other embodiments, the method further includes: outputting an information parameter of a value group of the device parameter, the information parameter including a position of the value group in value groups of the device parameter, or a percentage of the value group in the target values, or the percentage of the value group in the target values and the percentage of the value group in the target values.

In another aspect, a data processing method is provided. The method includes: receiving sample screening conditions of an input on a condition selection interface; acquiring sample data of each sample of a plurality of samples corresponding to the sample screening conditions, the sample data including a value, which is acquired at each acquisition time, of a device parameter of a device through which the sample passes, and a test result of the sample; dividing sample data of the plurality of samples into data of positive samples and data of negative samples according to test results of the plurality of samples; determining a sample segment point of each sample according to values of the device parameter, so as to obtain N value groups of target values corresponding to each sample, the sample segment point of each sample being used to represent an abrupt change point of the values of the device parameter of each sample, and the target values including values, a time difference between adjacent two acquisition times of which is less than a first threshold, in the values of the device parameter, and N being a positive integer greater than or equal to 1; determining a related quantized value according to a difference between an M-th value group of a positive sample and an M-th value group of a negative sample, the related quantized value being used to represent a degree of influence of the device parameter on a defective sample, and M being a positive integer less than or equal to N; and displaying the related quantized value on an analysis result display interface.

In some embodiments, the method further includes sorting related quantized values according to magnitudes thereof. Displaying the related quantized value on the analysis result display interface includes: displaying a sorting of value groups of the device parameter corresponding to the related quantized values on the analysis result display interface.

In some other embodiments, the method further includes: displaying an information parameter of a value group of the device parameter on the analysis result display interface, the information parameter including a position of the value group in value groups of the device parameter, or a percentage of the value group in the target values, or the position of the value group in value groups of the device parameter and the percentage of the value group in the target values.

In yet another aspect, an electronic device is provided. The electronic device includes a processor and a memory for storing instructions executed by the processor. The processor is configured to execute the executable instructions to perform one or more steps of the data processing method as described in any one of the above aspects and embodiments.

In yet another aspect, a non-transitory computer-readable storage medium is provided. The computer-readable storage medium stores computer program instructions that, when run on a processor, cause the processor to execute one or more steps of the data processing method as described in any one of the above embodiments.

### BRIEF DESCRIPTION OF THE DRAWINGS

In order to describe technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, and are not limitations on actual sizes of products, actual processes of methods and actual timings of signals involved in the embodiments of the present disclosure.

FIG. 1 is a diagram showing a structure of a data processing system, in accordance with some embodiments;

FIG. 2 is a diagram showing a structure of an electronic device, in accordance with some embodiments;

FIG. 3 is a flow diagram of a data processing method, in accordance with some embodiments;

FIG. 4 is a diagram showing a result of determining reference sample segment points, in accordance with some embodiments;

FIG. 5 is a flow diagram of determining a sample segment point of a sample, in accordance with some embodiments;

FIG. 6 is a flow diagram of determining a first difference, a second difference, and a difference value between the first difference and the second difference, in accordance with some embodiments;

FIG. 7 is a flow diagram of another data processing method, in accordance with some embodiments;

FIG. 8 is a diagram showing a structure of a condition selection interface, in accordance with some embodiments;

FIG. 9 is a diagram showing a structure of a result variable input interface, in accordance with some embodiments;

FIG. 10 is a diagram showing a structure of a causal variable input interface, in accordance with some embodiments;

FIG. 11 is a diagram showing a sample distribution, in accordance with some embodiments;

FIG. 12 is a diagram showing a structure of an analysis result display interface on which related quantized values of one value group are displayed, in accordance with some embodiments;

FIG. 13 is a diagram showing a structure of an analysis result display interface on which related quantized values of two value groups are displayed, in accordance with some embodiments;

FIG. 14 is a diagram showing a structure of a data processing apparatus, in accordance with some embodiments; and

FIG. 15 is a diagram showing a structure of another data processing apparatus, in accordance with some embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed in an open and inclusive meaning, i.e., “including, but not limited to”. In the description, the term such as “one embodiment”, “some embodiments”, “exemplary embodiments”, “example”, “specific example” or “some examples” is intended to indicate that specific features, structures, materials or characteristics related to the embodiment(s) or example(s) are included in at least one embodiment or example of the present disclosure. Schematic representation of the above term does not necessarily refer to the same embodiment(s) or examples(s). In addition, the specific features, structures, materials or characteristics may be included in any one or more embodiments or examples in any suitable manner.

Hereinafter, the terms “first” and “second” are only used for descriptive purposes, and are not to be construed as indicating or implying relative importance or implicitly indicating the number of indicated technical features. Thus, a feature defined with “first” or “second” may explicitly or implicitly include one or more of the features. In the description of the embodiments of the present disclosure, the term “a plurality of/the plurality of” means two or more unless otherwise specified.

In the description of some embodiments, the terms “coupled” and “connected” and derivatives thereof may be used. For example, the term “connected” may be used in the description of some embodiments to indicate that two or more components are in direct physical or electrical contact with each other. For another example, the term “connected” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the contents herein.

As used herein, the term “if”, depending on the context, is optionally construed as “when”, “in a case where”, “in response to determining” or “in response to detecting”. Similarly, depending on the context, the phrase “if it is determined . . . ” or “if [a stated condition or event] is detected” is optionally construed as “in a case where it is determined . . . ”, “in response to determining . . . ”, “in a case where [the stated condition or event] is detected” or “in response to detecting [the stated condition or event]”.

The use of the phase “applicable to” or “configured to” herein means an open and inclusive expression, which does not exclude devices that are applicable to or configured to perform additional tasks or steps.

In addition, the use of the phase “based on” is meant to be open and inclusive, since a process, step, calculation or other action that is “based on” one or more of the stated conditions or values may, in practice, be based on additional conditions or values exceeding those stated.

As used herein, the term “about” or “approximately” includes a stated value and an average value within an acceptable range of deviation of a particular value. The acceptable range of deviation is determined by a person of ordinary skill in the art in view of measurement in question and errors associated with measurement of a particular quantity (i.e., limitations of a measurement system).

In the related art, in a manufacturing process of a product, a device, through which the product passes, involved in any process step and device parameters will affect performance of the product, and may cause substandard performance (also referred to as defect) of the product. However, since a test station for testing the performance of the product may generally be provided after a plurality of devices, it may not be able to locate a device that causes the defect in time. In a process of locating the device that causes the defect, there is a need to trace each device involved in the process step, locate the device, and then acquire device parameters (including information such as temperature, pressure, humidity and flow rate) of the device. The device has numerous device parameters. For example, device parameters of a sub-unit of the device may be up to 130, and if the device includes 10 sub-units, the device has a total of 13000 device parameters. Therefore, it takes a lot of time to confirm the device parameters one by one.

Based on this, embodiments of the present disclosure provide a data processing method. The data processing method includes: acquiring sample data of each sample of a plurality of samples produced within a preset time period; dividing sample data of the samples into data of positive samples and data of negative samples according to test results of the samples; determining a sample segment point of each sample, so as to obtain N value groups (also referred to as sequence segments) of target values corresponding to each sample, the sample segment point of each sample being used to represent an abrupt change point of values of a device parameter of each sample; and determining a related quantized value according to a difference between an M-th value group of a positive sample and an M-th value group of a negative sample, the related quantized value being used to represent a degree of influence of the device parameter on a defective sample, N being a positive integer, and M being a positive integer less than or equal to N. In this way, a detection efficiency may be improved, and it is convenient for a user to make a decision quickly and find out reasons for sample defect.

The technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

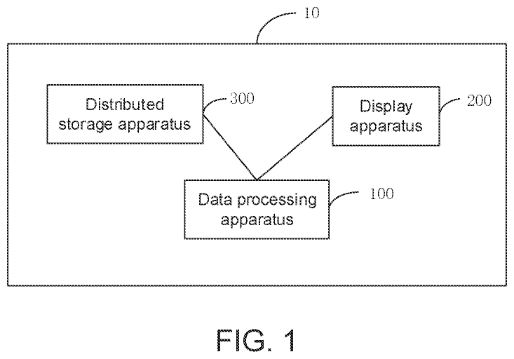

The data processing method provided in the embodiments of the present disclosure is applicable to a data processing system 10 shown in FIG. 1. The data processing system 10 includes a data processing apparatus 100, a display apparatus 200 and a distributed storage apparatus 300. The data processing apparatus 100 is coupled to the display apparatus 200 and the distributed storage apparatus 300.

The distributed storage apparatus 300 is configured to store production data generated by a plurality of devices (which may also be referred to as factory equipments). For example, the production data generated by the plurality of devices includes sample data of the plurality of devices. For example, the sample data includes identifiers of devices through which the plurality of samples pass in their respective production processes, parameters corresponding to the devices, test results and production time of the plurality of samples. Each sample passes through at least one device in its production process.

The distributed storage apparatus 300 stores relatively complete data (such as a database). The distributed storage apparatus 300 may include a plurality of hardware memories, and different hardware memories are distributed in different physical locations (such as in different factories, or on different production lines), and communicate with each other through wireless transmission (such as the network), so that the data is distributed but logically form a database based on big data technology.

A large amount of raw data of different sample devices is stored in corresponding manufacturing systems, e.g., in relational databases (e.g., Oracle or Mysql) of the systems such as a yield management system (YMS), a fault detection and classification (FDC), and a manufacturing execution system (MES). Such raw data may be extracted in an original table manner by a data extraction tool (e.g., Sqoop or Kettle) to be transmitted to the distributed storage apparatus 300 (e.g., a Hadoop distributed file system (HDFS)), so as to reduce the load on the devices and manufacturing systems, and facilitate data reading of the data processing apparatus 100 in a subsequent process.

The data in the distributed storage apparatus 300 may be stored by a Hive tool or in an Hbase database format. For example, according to the Hive tool, the raw data is first stored in the database; then, the raw data may be subjected to pretreatment (e.g., data cleaning and data conversion) in the Hive tool to obtain a data warehouse of the sample data of the samples. The data warehouse may be connected to the display apparatus 200, the data processing apparatus 100, etc. through different application programming interfaces (APIs) to realize data interaction with these devices. The display apparatus 200 displays selection interfaces, and the selection interface is used for selection of screening conditions by a user. The screening conditions include result variables, causal variables and filter conditions (such as product categories and time periods). The data processing apparatus 100 performs intelligent mining to perform defect diagnosis and analysis, and then obtains an analysis result through the defect diagnosis and analysis. The display apparatus 200 displays the analysis result to the user on an analysis result display interface.

Since a plurality of devices in a plurality of factories are involved, the raw data is in a large volume. For example, all devices may generate several hundred gigabytes of raw data every day, and generate dozens of gigabytes of raw data every hour.

In the embodiments of the present disclosure, storage of massive structured data may be realized by using the relational database, and calculation of massive data may be realized by using distributed computing. For example, the storage and calculation of the massive structured data may be realized by using a big data solution of a distributed file system (DFS).

The big data technology based on the DFS allows the use of a plurality of inexpensive hardware devices to build large clusters to process massive amounts of data. For example, the Hive tool is a data warehouse tool based on Hadoop, which may be used for data extraction, transformation and loading (ETL). The Hive tool defines a simple SQL-like query language, and also allows Mapper and Reducer in user-defined MapReduce to default complex analysis work that the tool cannot do. The Hive tool does not have a designated data storage format, nor does it create an index for the data. Users may freely organize tables therein to process the data in the database. It can be seen that, the parallel processing of the DFS may satisfy the storage and processing requirements of massive data. Users may use SQL query for simple data processing, and use custom functions to realize complex data processing. Therefore, during analysis of the massive data of a factory, the data of the factory's database needs to be extracted into a DFS. In this way, not only the raw data will not be damaged, but also the data analysis efficiency will be improved.

For example, the distributed storage apparatus 300 may be one memory, or may be a plurality of memories, or may be a general term for a plurality of storage elements. For example, the memories may include a random access memory (RAM) or a double data rate synchronous dynamic random access memory (DDR SRAM), or may include a non-volatile memory, such as a disk storage or a flash memory.

The data processing apparatus 100 may be any terminal device, server, virtual machine or server cluster.

The display apparatus 200 may be a display or a product including a display, such as a television, a computer (an all-in-one computer or a desktop computer), a tablet computer, a mobile phone, or an electronic picture screen. For example, the display apparatus may be any apparatus that displays an image whether in motion (e.g., a video) or stationary (e.g., a static image), and whether literal or graphical. More specifically, it is anticipated that the described embodiments may be implemented in or associated with a variety of electronic devices, which include (but are not limited to) a game console, a television monitor, a flat panel display, a computer monitor, an automotive display (e.g., an odometer display), a navigator, a cockpit controller and/or display, an electronic photo, an electronic billboard or sign, a projector, a building structure, packaging, and an aesthetic structure (e.g., a display for an image of a piece of jewelry).

For example, the display apparatus 200 described herein may include one or more displays, and include one or more terminals with a display function. Therefore, the data processing apparatus 100 may send data processed by the data processing apparatus 100 (such as the influencing parameters) to the display apparatus 200, and then the display apparatus 200 displays the processed data. That is, a complete interaction (controlling and receiving results) between the user and the data processing system 10 may be achieved through the interface (i.e., a user interaction interface) of the display apparatus 200.

It can be understood that, functions of the data processing apparatus 100, the display apparatus 200 and the distributed storage apparatus 300 may be integrated into one or two electronic devices, or may be implemented separately by different devices, which is not limited in the embodiments of the present disclosure.

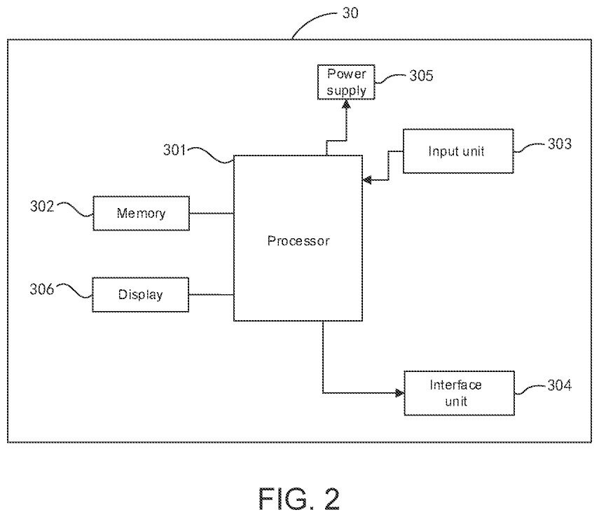

The functions of the data processing apparatus 100, the display apparatus 200 and the distributed storage apparatus 300 may each be implemented by the electronic device 30 shown in FIG. 2. The electronic device 30 shown in FIG. 2 includes but is not limited to a processor 301, a memory 302, an input unit 303, an interface unit 304, and a power supply 305. Optionally, the electronic device includes a display 306.

The processor 301 is a control center of the electronic device, and connects all parts of the entire electronic device through various interfaces and lines. By running or executing software programs and/or modules stored in the memory 302 and calling data stored in the memory 302, the processor 301 controls execution of various functions of the electronic device and processes the data, thereby monitoring the overall electronic device. The processor 301 may include one or more processing units; optionally, the processor 301 may be integrated with an application processor and a modem processor. The application processor mainly deals with an operating system, a user interface, application programs, and the like, and the modem processor mainly deals with wireless communication. It can be understood that, the modem processor may also not be integrated in the processor 301.

The memory 302 may be used to store software programs and various data. The memory 302 may mainly include a program storage partition and a data storage partition. The program storage partition may store the operating system, application program(s) required by at least one function unit, and the like. In addition, the memory 302 may be a high-speed RAM, or may be a non-volatile memory, such as at least one disk storage, a flash memory or any other volatile solid state storage. Optionally, the memory 302 may be a non-transitory computer-readable storage medium. For example, the non-transitory computer-readable storage medium may be a read-only memory (ROM), a RAM, a CD-ROM, a magnetic tape, a floppy disk or an optical data storage.

The input unit 303 may be a device such as a keyboard or a touch screen.

The interface unit 304 is an interface for connecting an external device to the electronic device 30. For example, the external device may include a wired or wireless headset port, an external power supply (or a battery charger) port, a wired or wireless data port, a memory card port, a port for connecting a device with an identification module, an audio input/output (I/O) port, a video I/O port, or a headphone port. The interface unit 304 may be used to receive input (e.g., data information) from the external device and transmit the received input to one or more elements in the electronic device 30, or the interface unit 304 may be used to transfer data between the electronic device 30 and the external device.

The power supply 305 (e.g., a battery) may be used to supply power to various components. Optionally, the power supply 305 may be logically connected to the processor 301 through a power management system, thereby implementing functions such as charging management, discharging management, and power consumption management through the power management system.

The display 306 is used to display information input by the user or information (such as data processed by the processor 301) provided to the user. The display 306 may include a display panel. The display panel may be configured in a form of a liquid crystal display (LCD), an organic light-emitting diode (OLED), or the like. In a case where the electronic device 30 is the display apparatus 200, the electronic device 30 includes the display 306.

Optionally, computer instructions in the embodiments of the present disclosure may also be referred to as application program codes or systems, which are not specifically limited in the embodiments of the present disclosure.

It will be noted that, FIG. 2 only illustrates an example for the electronic device, which does not limit the electronic device to which the embodiments of the present disclosure are applicable. In actual implementations, the electronic device may include more or fewer devices than those shown in FIG. 2.

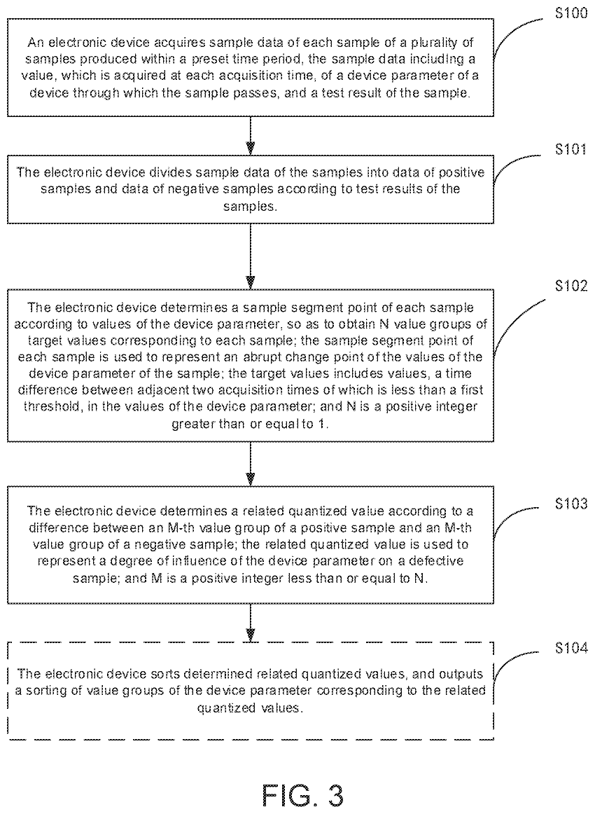

FIG. 3 is a flow diagram of a data processing method provided in the embodiments of the present disclosure. The method may be applied to the electronic device shown in FIG. 2. The method, as shown in FIG. 3, may include the following steps.

In S100, the electronic device acquires sample data of each sample of a plurality of samples produced within a preset time period. The sample data includes a value, which is acquired in each acquisition time, of a device parameter of a device through which the sample passes, and a test result of the sample.

In a possible implementation, the electronic device receives sample data of each sample of a plurality of samples of the same model that are produced by various devices on a sample production line within the preset time period.

In another possible implementation, the electronic device performs data preprocessing through the following steps, and acquires the sample data of each sample in the plurality of samples produced within the preset time period.

In a first step, the electronic device acquires initial sample data. The initial sample data is initial sample data of each sample produced within the preset time period.

For example, the electronic device acquires batch information related to a product of a specific model and/or identification informations of raw materials for producing the product within the preset time period from the Hbase database, and acquires sample data of each of samples of a same model and produced within the preset time period as the initial sample data according to the obtained batch information or identification informations from the memory or the distributed storage system.

It will be noted that, the sample in the embodiments of the present disclosure may be a display panel in a production line for display panels. Of course, the sample in the embodiments of the present disclosure may also be any other product. The sample may be a display panel motherboard (i.e., display panel glass), which may be produced into a plurality of display panels.

The representation manner of the test result of the sample is not limited in the embodiments of the present disclosure. For example, the test result may be 0 or 1, in which 0 indicates that the sample belongs to a type, and 1 indicates that the sample belongs to another type. In an example, 0 indicates that the sample belongs to a non-defective sample, and 1 indicates that the sample belongs to a defective sample. Defects may be classified into different types according to needs. For example, the defects may be classified according to a direct influence that the defects have on a performance of the sample into, for example, a bright line defect, a dark line defect, a hot spot defect, etc.; or classified according to a specific cause of the defect into, for example, a signal line short circuit defect, an alignment defect, etc.; or classified according to a general cause of the defects into, for example, an array process defect, a color film process defect, etc.; or classified according to a severity of the defect into, for example, a defect leading to scrapping, a defect leading to lower quality, etc. Alternatively, the defects may not be classified. That is, as long as there is a defect in the sample, the sample is deemed to be defective, otherwise, it is deemed to be non-defective. In the embodiments of the present disclosure, the test result of each sample of the plurality of samples corresponds to a same variable.

For example, it is assumed that, in the sample data obtained by the electronic device, sample data corresponding to device parameter 1 of device A is shown in Table 1 below.

TABLE 1

| | | | | | | | | |
|---|---|---|---|---|---|---|---|---|
| 1 | Value | 49.5456 | 49.5823 | 46.9352 | | | | |
| | Time | 00:01:47 | 00:01:48 | 00:01:49 | | | | |
| 2 | Value | 47.0249 | 47.0248 | 47.0248 | 47.0013 | 47.0013 | | |
| | Time | 07:01:23 | 07:01:24 | 07:01:25 | 07:01:26 | 07:01:27 | | |
| 3 | Value | 49.5344 | 46.8889 | 46.8889 | 46.8889 | 46.8572 | 46.9974 | 47.0013 |
| | Time | 16:05:11 | 16:05:12 | 16:05:13 | 16:05:14 | 16:05:15 | 16:05:16 | 16:05:17 |
| 4 | Value | 47.0249 | 47.0248 | 47.0248 | 47.0013 | 47.0014 | | |
| | Time | 07:01:23 | 07:01:24 | 07:01:25 | 07:01:26 | | | |

In Table 1, in a first column and first row, 1 is an identifier of sample 1; in a first row, 49.5456, 49.5823 and 46.9352 are values of device parameter 1; in a second row, time 00:01:47 is a production time in a case where the value of device parameter 1 is 49.5456, time 00:01:48 is a production time in a case where the value of device parameter 1 is 49.5823, and time 00:01:49 is a production time in a case where the value of device parameter 1 is 46.9352. The rest is similar to this, and details will not be provided here.

In a second step, the electronic device trims the initial sample data, or filters the initial sample data, or trims and filters the initial sample data, so as to obtain the sample data of each sample of the plurality of samples produced within the preset time period.

Through at least one of the following manners, the electronic device may trim or filter the initial sample data, or trim and filter the initial sample data, so as to obtain the sample data of each sample of the plurality of samples produced within the preset time period.

For a first manner, according to test results of the samples, the electronic device divides initial sample data of the samples into initial data of positive samples (also referred to as non-defective samples) and initial data of negative samples (also referred to as defective samples). For the initial data of the negative samples in the initial sample data, the electronic device filters initial data of a negative sample in the initial data of the negative samples, a ratio of the number of values of a device parameter of which to the number of acquisition times does not satisfy a preset condition. For example, the electronic device filters initial data of a negative sample, 95% of the number of values of a device parameter of which is greater than the number of acquisition times of the device parameter, from the initial sample data. Based on the initial sample data in Table 1, in sample data of a sample with a sample identifier of 4, the number of values of a device parameter is 5, and the number of acquisition times of the device parameter is 4. Since 95% of the number (i.e., 5) of the values of the device parameter is greater than 4, the electronic device filters the sample data of the sample with the sample identifier of 4.

For a second manner, according to the test results of the samples, the electronic device divides initial sample data of the samples into initial data of positive samples (also referred to as non-defective samples) and initial data of negative samples (also referred to as defective samples). Through the following steps, the electronic device acquires the numbers of target values of the positive samples in the initial sample data of the samples, determines a value range according to the numbers of the target values of the positive samples, and filters initial data of a positive sample, the number of target values of which is outside the value range, in the initial sample data of the samples produced within the preset time period.

In a first step, the electronic device acquires the numbers of the target values of the positive samples in the initial sample data of the samples. The target values includes values, a time difference between adjacent two acquisition times of which is less than a first threshold (e.g., greater than 1 second), in the values of the device parameter.

Based on the examples in Table 1, target values of the sample with the sample identifier of 1 are 49.5456, 49.5823 and 46.9352. The number of the target values of the sample with the sample identifier of 1 is 3. Similarly, it may be obtained that the number of target values of the sample with the sample identifier of 2 is 5, the number of target values of the sample with the sample identifier of 3 is 7, and the number of target values of the sample with the sample identifier of 4 is 5.

In a second step, the electronic device determines the value range according to the numbers of the target values of the positive samples in the initial sample data of the samples.

In a possible implementation, the electronic device acquires a median and an interquartile range (IQR) of the numbers of the values of the device parameter, and determines the value range according to the median and the IQR.

Based on the examples of the sample data obtained in the first step and the sample data obtained after the filtering in the first manner, the median of the numbers of the values of the device parameter is 5, and the IQR satisfies the following formula: IQR=Q3-Q1, where Q3 is a third quartile, and Q1 represents a first quartile. Therefore, it is obtained that Q3 is 6, Q1 is 4, and the IQR is 2. The electronic device determines that an upper bound of the value range is a sum of the median and quadruple the interquartile range, and a lower bound of the value range is a difference between the median and quadruple the interquartile range, so that it is obtained that the upper bound of the value range is 13, and the lower bound of the value range is −3.

In a third step, the electronic device filters the initial data of the positive sample, the number of the target values of which is outside the determined value range, in the initial sample data.

In an example where the numbers of the values of the device parameter 1 are 3, 5, and 7, the numbers of the values of the device parameter are all in the value range of −3 to 13, and thus the electronic device does not filter initial data of any positive sample.

For a third manner, the electronic device determines a trimming length according to at least a median of the numbers of target values of the initial sample data of the samples, and trims the acquired initial sample data of each sample according to the trimming length.

In a possible implementation, the electronic device acquires the number of the target values of the initial sample data of each sample. The electronic device acquires the median of the numbers of the target values, and determines the trimming length according to the obtained median and a preset percentage. The electronic device trims target values, the number of which is the trimming length, forward from a start acquisition time of the target values, or trims target values, the number of which is the trimming length, backward from an end acquisition time of the target values.

Based on the example in the second manner, a median of the numbers of the target values of parameter 1 is 5, and the preset percentage is 3%. Thus, it is obtained that the trimming length of the target values of parameter 1 is a product of 5 and 3%, i.e., 0.15, and then the number 0.15 is rounded down to obtain that the trimming length is 0. Therefore, the electronic device does not need to trim the initial data of the positive sample in the initial sample data.

In S101, the electronic device divides sample data of the samples into data of positive samples and data of negative samples according to test results of the samples.

Based on the examples in Table 1, assuming that test results of the samples with the sample identifiers of 1 to 3 are non-defective, and a test result of the sample with the sample identifier of 4 is defective, in the divided sample data, the data of the positive samples includes data of the samples with the sample identifiers of 1 to 3, and the data of the negative samples includes data of the sample with the sample identifier of 4.

In S102, the electronic device determines a sample segment point of each sample according to values of the device parameter, so as to obtain N value groups of target values corresponding to each sample. The sample segment point of each sample is used to represent an abrupt change point of the values of the device parameter of the sample. The target values includes values, a time difference between adjacent two acquisition times of which is less than the first threshold, in the values of the device parameter, and N is a positive integer greater than or equal to 1.

In a possible implementation, the electronic device determines the sample segment point of each sample through the following steps.

In a first step, the electronic device determines sample data of a reference sample according to the obtained values of the device parameter. The reference sample is a positive sample in the plurality of samples.

The electronic device may perform Fourier transform on values of the device parameter of each of the positive samples, take a minimum number of transformed values of the device parameter of the positive samples as a trimming number, and acquire front values, the number of which is the trimming number, in the values of the device parameter of each of the positive samples, so as to obtain a plurality of trimming value groups, the number of values included in each trimming value group being the trimming number. The electronic device acquires, according to an order of values in each trimming value group, a median of values at each position in the plurality of trimming value groups, so as to obtain a median sequence. And the electronic device determines a sample with a minimum difference value with the median sequence in the positive samples as the reference sample.

Optionally, if the number of positive samples (abbreviated as a sample number below) in the sample data corresponding to the device parameter is greater than or equal to 200, the electronic device extracts 1% of sample data corresponding to the positive samples. If the sample number is greater than 20 and is less than 200, then the electronic device extracts sample data of 20 samples from the sample data corresponding to the positive samples. If the sample number is less than or equal to 20, then the electronic device extracts the sample data of all positive samples. The electronic device determines the reference sample from the extracted samples through the above method. In this way, determining the reference sample from the extracted samples may improve a data processing efficiency.

Based on the examples of the sample data of the samples with the sample identifiers of 1, 2 and 3 in Table 1, the number of the values of the device parameter of the sample with the sample identifier of 1 is 3, the number of the values of the device parameter of the sample with the sample identifier of 2 is 5, and the number of the values of the device parameter of the sample with the sample identifier of 3 is 7, in which 3 is the minimum number of the values of the device parameter. The electronic device determines that the trimming number is 3. A trimming value group of the sample with the sample identifier of 1 obtained by the electronic device is (49.5456, 49.5823, 46.9352), a trimming value group of the sample with the sample identifier of 2 is (47.0249, 47.0248, 47.0248), and a trimming value group of the sample with the sample identifier of 3 is (49.5344, 46.8889, 46.8889). Then, the electronic device obtains that a median at a first position is 49.5344, a median at a second position is 47.0248, and a median at a third position is 46.8889. Thus, the electronic device obtains that the median sequence is (49.5344, 47.0248, 46.8889). In the sample data of the samples with the sample identifiers of 1, 2 and 3, a difference value between the sample with the sample identifier of 3 and the median sequence is the minimum, and thus the electronic device determines the sample with the sample identifier of 3 as the reference sample.

In a second step, the electronic device determines a signal-to-noise ratio of the reference sample, and an absolute value of the signal-to-noise ratio is a signal-to-noise ratio absolute value.

In a third step, the electronic device takes a value, an absolute value of which is greater than the signal-to-noise ratio absolute value, in filtered values of the device parameter, as a reference sample segment point.

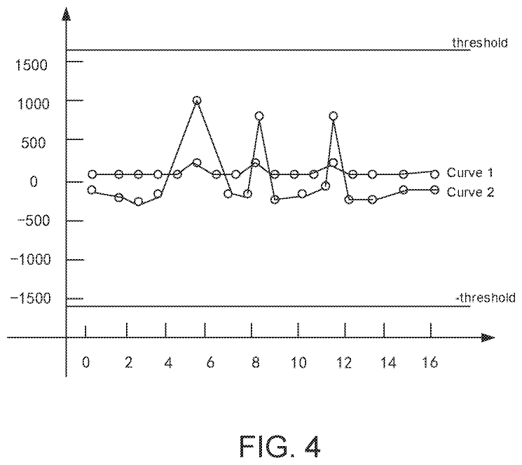

For example, assuming that the signal-to-noise ratio absolute value determined by the electronic device is threshold, the electronic device takes a value that is outside a threshold range of [-threshold, threshold], in the filtered values of the device parameter, as the reference sample segment point. As shown in FIG. 4, value points in curve 1 are sample data, value points in curve 2 are sample data obtained by using a high-pass filter, and there is no value outside the threshold range in FIG. 4. Thus, the sample data in FIG. 4 is taken as a value group, and the abscissa in FIG. 4 is serial numbers corresponding to the acquisition times of the values of the device parameter of the sample data.

Optionally, the electronic device may adjust the reference sample segment point according to a fluctuation range of values of the device parameter near the determined reference sample segment point. For example, in a case where a difference between values of the device parameter on both sides of the determined reference sample segment point is smaller than a fluctuation threshold, the reference sample segment point is adjusted. The fluctuation threshold is used to assist in determining the abrupt change point of the values of the device parameter.

In a fourth step, the electronic device determines the sample segment point of each sample according to a reference ratio and the reference sample segment point. Value groups, which are obtained based on sample segment points determined by a same reference sample segment point, correspond to each other. The reference ratio is a ratio of the number of values of the device parameter of the reference sample to the number of the values of the device parameter of each sample.

In a possible implementation, for each sample, the electronic device determines an initial sample segment point of each sample according to the reference ratio and the reference sample segment point. In addition, the electronic device acquires, according to the determined initial sample segment point and a size of a preset window, a correlation between value groups of the device parameter, in which one value group is at a distance within a size range of the preset window from the initial sample segment point, and the other value group is at a distance within the size range of the preset window from the reference sample segment point. Furthermore, the electronic device corrects the initial sample segment point of each sample according to the obtained correlation.

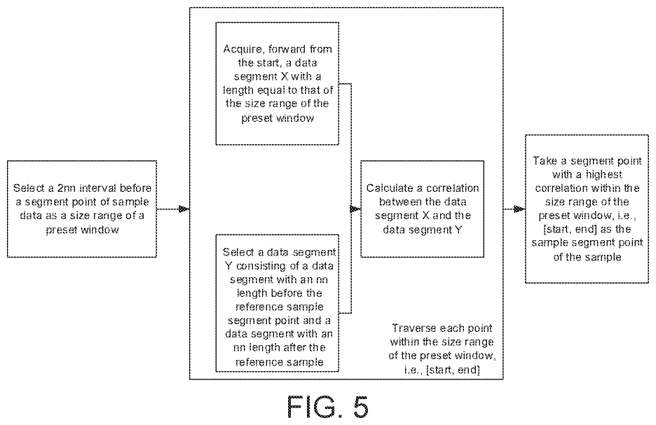

As shown in FIG. 5, assuming that the reference ratio is 2, and the electronic device selects a 2nn interval before the segment point of the sample data as the size range of the preset window, i.e., [start, end]. Based on this, the electronic device traverses each point within the size range of the preset window, i.e., [start, end]. The electronic device acquires, forward from the start, a data segment X with a length equal to that of the size range of the preset window, and further selects a data segment Y consisting of a data segment with an nn length before the reference sample segment point and a data segment with an nn length after the reference sample. In addition, the electronic device calculates a correlation between the data segment X and the data segment Y by using the Pearson correlation coefficient. Then, the electronic device takes a segment point with a highest correlation within the size range (i.e., [start, end]) of the preset window as the sample segment point of the sample.

It can be understood that, the sample segment point of each sample divides the target values corresponding to the sample into N value groups, N being a positive integer greater than or equal to 1. In a case where N is equal to 1, it means that, it is determined that there is no sample segment point of the sample, there is no need to divide the target values of the sample, and the target values are in a single value group. During actual production, a device may include a plurality of recipe steps. The recipe steps are instructions used to indicate how the device should process a sample, which are also referred to as settings of a device parameter of the device to process the sample. For example, a recipe step includes values of the device parameter and times corresponding to the values of the device parameter. In a recipe step, a difference between acquisition times of values of a same device parameter is less than the first threshold (e.g., greater than 1 second).

Based on the examples in Table 1, the electronic device determines that a segment point of the sample with the sample identifier of 2 is 47.0013. Then, the electronic device segments the sample data of the sample with the sample identifier of 2 into two value groups, in which a first value group includes values 47.0249, 47.0248 and 47.0248, and a second value group includes values 47.0013 and 47.0013.

It can be understood that, a variation trend of obtained values in a same value group tends to be same. The values in the same value group are stable and do not change abruptly. Therefore, a related quantized value, which is determined based on a difference between a value group of the device parameter of a positive sample and a value group at a same position of the device parameter of a negative sample, may be used to represent a degree of influence of the value group on a defective sample.

In S103, the electronic device determines a related quantized value according to a difference between an M-th value group of a positive sample and an M-th value group of a negative sample. The related quantized value is used to represent a degree of influence of the device parameter on a defective sample, and M is a positive integer less than or equal to N.

In a possible implementation, the electronic device determines the related quantized value through the following steps.

In S103-1, the electronic device determines a first value of statistical indices of the M-th value group of the negative sample. The statistical indices are used to represent a centralized trend or a variation trend of values in the value group.

The statistical indices used to represent the centralized trend of the values in the value group include at least one of features that reflect integrity of the value group, such as a maximum value, a minimum value, a mean value, a median, a standard deviation, a subscript of the minimum value and a subscript of the maximum value.

The statistical indices used to represent the variation trend of the values in the value group include at least one of the following: a slope, a range difference, a sum of differences in downtrends (Stat_downtrend), a sum of differences in uptrends (Stat_uptrend), a sum of positive values (Positive_sum), a maximum value in sums of ascending intervals (Positive_max), a start subscript of an interval with a maximum sum in consecutive ascending intervals (Positive_maxstart), an end subscript of the interval with the maximum sum in the consecutive ascending intervals (Positive_maxend), a sum of negative values (Negative_sum), a maximum value in sums of descending intervals (Negative_max), a start subscript of an interval with a maximum sum in consecutive descending intervals (Negative_maxstart Index), an end subscript of the interval with the maximum sum in the consecutive descending intervals (Negative_maxend index), or a sum of absolute values (L1_NORM).

The subscript is used to represent the position of the value in the value group. For example, assuming that the value group is (−2, 1, −1, 2, 3, −3, 4, −4), a subscript of a first value-2 in the value group is 1, a subscript of a second value 1 is 2, and so on, and details will not be repeated here.

Based on the example of the value group (−2, 1, −1, 2, 3, −3, 4, −4), a maximum value in the values of the device parameter included in the value group is 4; a minimum value is −4; a mean value is 0 ((−2+1+−1+2+3+−3+4+−4)/8=0), a median is 0 ((−1+1)/2=0); a standard deviation std satisfies the formula

$$std = \sqrt{\frac{1}{n - 1} {\sum }_{i = 1}^{8} {( {x}_{i} - \overline{x} )}^{2} ,}$$

where x₁ corresponds to −2, xg corresponds to −4, and the rest is similar to this, and x is the mean value of −2, 1, −1, 2, 3, −3, 4 and −4, so that the standard deviation obtained through calculation is 2.93; Range is a difference between the maximum value and the minimum value, which is 8 (4−(−4)=8); Index_min is the subscript of the minimum value, which is 8; Index_max is the subscript of the maximum value, which is 7; Stat_downtrend is −16 (−2−6−8=−16); Stat_uptrend is 14 (3+3+1+7=14); the slope satisfies the slope formula:

$$α = \frac{n \sum ( xy ) - \sum x \sum y}{n \sum {x}^{2} - {( \sum x )}^{2}} ,$$

and the slope obtained through calculation is −0.21428571; Positive_sum is 10; Positive_max is 5 (2+3=5); Positive_maxstart is 4; an interval with a maximum sum in consecutive ascending intervals is [2, 3], and a subscript of 2 is 4; Positive_maxend is 5; the interval with the maximum sum in the consecutive ascending intervals is [2, 3], and a subscript of 3 is 5; Negative_sum is a sum of negative values, i.e., −10 (−2−1−3−4=−10); Negative_max is a maximum value in sums of descending intervals, and −4 is the maximum value in the sums of the descending intervals; Negative_maxstart is a start index of an interval with a maximum sum in consecutive descending intervals, and since −4 is the maximum value in the sums of the descending intervals, and a subscript of −4 is 8, Negative_maxstart is 8; Negative_maxend is an end index of the interval with the maximum sum in the consecutive descending intervals, and same as above, Negative_maxend is 8; L1_NORM is 20 (10−(−10)=20). Assuming that the statistical indices include the above 20 values, the first value of the statistical indices of the value group is a feature vector [−4, 4, 0, 0, 2.93, 8, 8, 7, −16, 14, −0.214, 10, 5, 4, 5, −10, −4, 8, 8, 20].

In S103-2, the electronic device determines a second value of statistical indices of the M-th value group of the positive sample.

Based on the example in S103-1, assuming that the value group in S103-1 is a first value group of the device parameter of the negative sample, the electronic device acquires a second value of statistical indices of a first value group of the device parameter of each positive sample.

In S103-3, the electronic device determines a difference between the first value and the second value.

In a possible implementation, the electronic device determines the difference between the first value and the second value according to a feature parameter of first values and a feature parameter of second values.

The feature parameter may include a value at a target position, or a population mean value, or the value at the target position and the population mean value.

In an example, the electronic device may determine the difference value between the first value and the second value by using the Kruskal Wallis test.

For example, assuming that the value at the target position is a median, the electronic device acquires a median in a plurality of first values and a median in a plurality of second values, and the electronic device determines a difference between the two medians as the difference between the first value and the second value.

In another example, the electronic device may determine the difference between the first value and the second value by using the T-test.

For example, the electronic device acquires a population mean value of a plurality of first values, and a population mean value of a plurality of second values. Then, the electronic device determines a difference between the two population mean values as the difference value between the first value and the second value.

In another possible implementation, the electronic device determines a first difference between a value at a target position in the first values and a value at the target position in the second values. The electronic device determines a second difference between the population mean value of the first values and the population mean value of the second values. Then, the electronic device determines the difference value between the first value and the second value according to the first difference, the second difference and a preset weight.

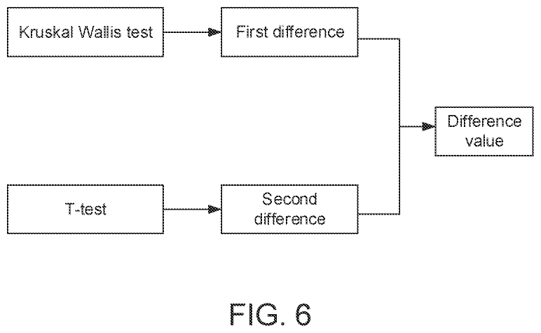

For example, as shown in FIG. 6, the electronic device determines the first difference according to the Kruskal Wallis test, and determines the second difference according to the T-test. Then, the electronic device determines a sum of 50% of the first difference and 50% of the second difference as the difference value (i.e., p value) between the first value and the second value.

In S103-4, the electronic device determines the related quantized value according to the difference.

It can be understood that, the greater the difference value, the greater correlation between the value group and the test result, and the greater the correlation, the greater the related quantized value of the value group of the device parameter.

It can be understood that, in a possible implementation, the electronic device may determine the first value of all statistical indices of the value group of the device parameter of the negative sample, and determine the second value of all statistical indices of the value group of the device parameter of the positive sample, and obtain the related quantized value of the value group according to the difference value between the first value and the second value.

In another possible implementation, the electronic device may also determine a first value of each statistical index of the value group of the device parameter of the negative sample, and determine a second value of a corresponding statistical index of the value group of the device parameter of the positive sample, obtain a difference value between the first value of each statistical index of the positive sample and the second value of the same statistical index of the negative sample, and obtain a plurality of related quantized values of the value group according to a plurality of difference values. The electronic device sorts the plurality of related quantized values, and then outputs the sorted related quantized values to the user. Therefore, it is easy for the user to determine which statistical index may well reflect the degree of influence of the value group on the defective sample.

Optionally, in S104, the electronic device sorts the determined related quantized values, and outputs a sorting of value groups of the device parameter corresponding to the related quantized values.

For example, the electronic device, according to magnitudes of the related quantized values, sorts the value groups of the device parameter corresponding to the related quantized values in a descending sorting. In this way, a value group that has a greatest influence on the defective sample is ranked first, so that it is easy for the user to find out causes for the defective sample.

In the embodiments of the present disclosure, the electronic device acquires the sample data of each sample of the plurality of samples produced within the preset time period, divides the sample data of the samples into the data of the positive samples and the data of the negative samples according to the test results of the samples, and determines the sample segment point of each sample. The sample segment point reflects the abrupt change point of the values of the device parameter, and the sample segment point of each sample divides the target values corresponding to the sample into a plurality of value groups. In this way, trends of values in each value group tend to be same. In addition, the electronic device determines the related quantized value according to the difference between the value group of the device parameter of the negative sample and the corresponding value group of the positive sample. The greater the difference, the greater the related quantized value, which indicates that the degree of influence of the value group on the defective sample is greater. Therefore, it is possible to make it easy for the user to find out the causes for the defective sample.

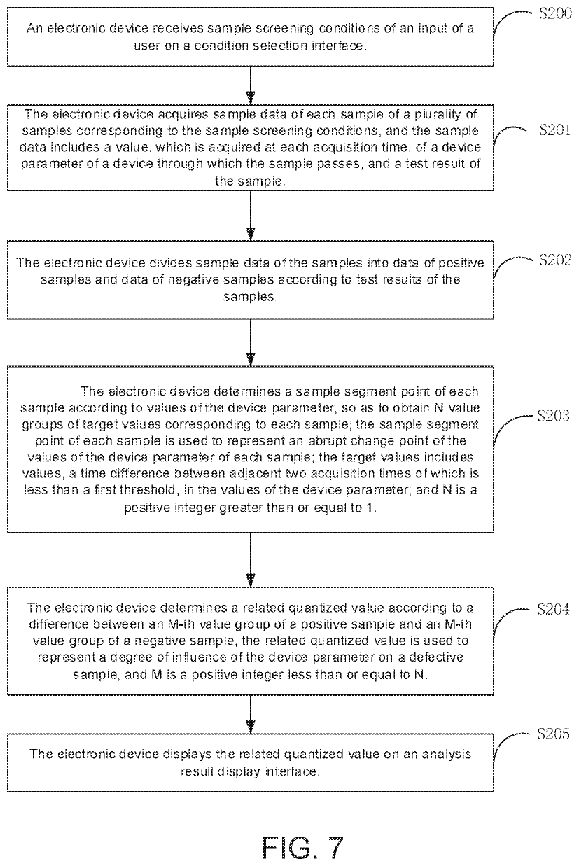

FIG. 7 is a flow diagram of another data processing method provided in embodiments of the present disclosure. The method may be applied to the electronic device shown in FIG. 2. As shown in FIG. 7, the method may include the following steps.

In S200, the electronic device receives sample screening conditions of an input of the user on a condition selection interface.

The sample screening conditions may include sample model, factory identification, station, process step, start time and end time.

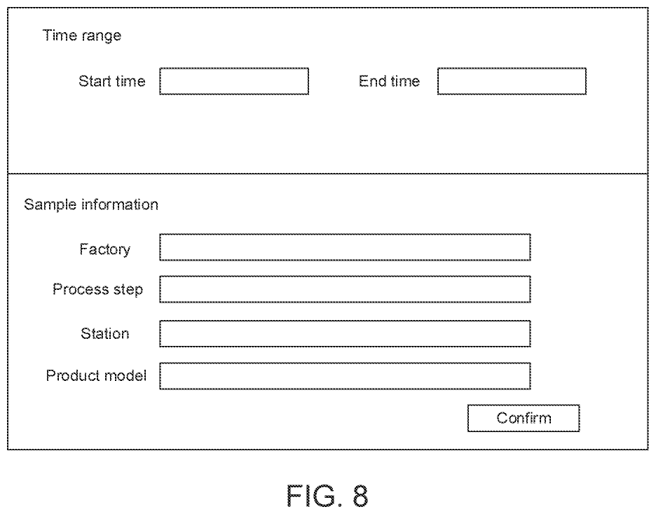

For example, the condition selection interface is shown in FIG. 8. In FIG. 8, the start time and the end time are used to receive an input time period, an input box corresponding to factory is used to receive the factory identification, an input box corresponding to process step is used to receive the process step, an input box corresponding to station is used to receive the station, and an input box corresponding to product model is used to receive the sample model. After inputting related information in the input boxes in FIG. 8, the user clicks the “confirm” button, and then the electronic device receives the input sample screening conditions.

Optionally, the sample screening conditions may further include a test result variable.

In a possible implementation, the electronic device reads a preset test result variable.

In another possible implementation, the electronic device, in response to an input of the user on a result variable input interface, acquires the input test result variable.

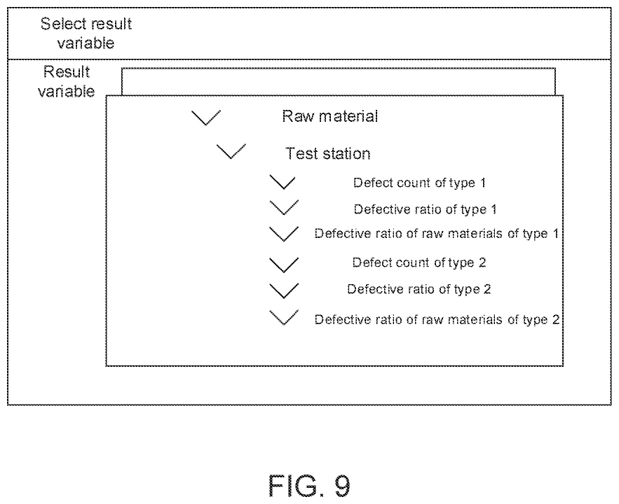

For example, the result variable input interface is shown in FIG. 9. After the user clicks the result variable input box in FIG. 9, the interface shown in FIG. 9 is presented. In FIG. 9, the raw material may be a panel motherboard, and the test station may be used for selection of a test station by the user. The test station includes at least six test result variables folded therein as follows. The defect count of type 1 may be used for selection of the number of the defective samples of type 1 by the user as a test result variable; the detective ratio of type 1 may be used for selection of the defective ratio of the samples of type 1 by the user as a test result variable; the detective ratio of raw materials of type 1 may be used for selection of the defective ratio of the raw materials of type 1 by the user as a test result variable; the defect count of type 2 may be used for selection of the number of the defective samples of type 2 by the user as a test result variable; the detective ratio of type 2 may be used for selection of the defective ratio of the samples of type 2 by the user as a test result variable; and the detective ratio of raw materials of type 2 may be used for selection of the defective ratio of the raw materials of type 2 by the user as a test result variable.

Optionally, the sample screening conditions may further include a device parameter, and the electronic device acquires the device parameter in response to an input of the user on a causal variable input interface.

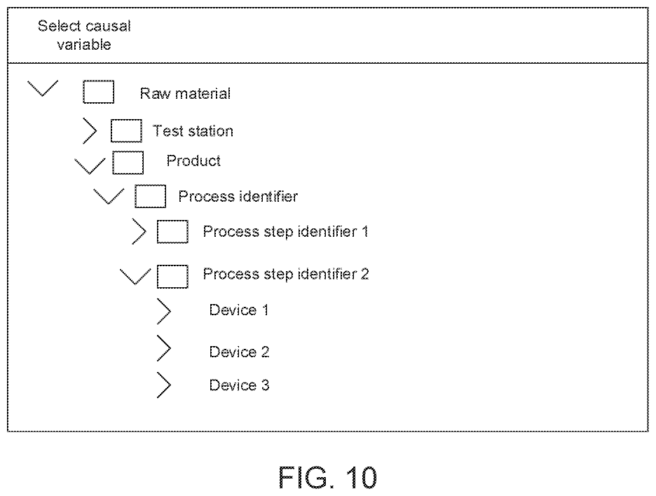

For example, the causal variable input interface is shown in FIG. 10. The raw material in FIG. 10 may be a panel motherboard. In FIG. 10, the test station may be used for a test station selection of the user, and the product may be used for selection of a product model by the user. In FIG. 10, the process identifier may be used for selection of a corresponding process by the user, and one process corresponds to at least one process step; process step identifier 1 and process step identifier 2 may each be used for selection of a process step by the user; a process step with the process step identifier of 2 corresponds to at least three devices, in which device 1 corresponds to one device, device 2 corresponds to another device, and device 3 corresponds to yet another device.

In S201, the electronic device acquires sample data of each sample of a plurality of samples corresponding to the sample screening conditions. The sample data includes a value, which is acquired at each acquisition time, of a device parameter of a device through which the sample passes, and a test result of the sample.

In S202, the electronic device divides sample data of the samples into data of positive samples and data of negative samples according to test results of the samples.

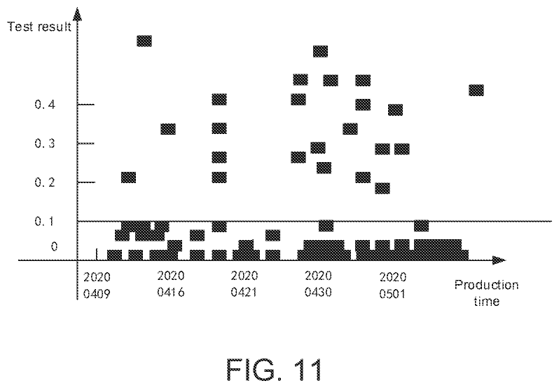

Optionally, after dividing the sample data of the samples into the data of the positive samples and the data of the negative samples, the electronic device displays the sample distribution shown in FIG. 11. In FIG. 11, the abscissa represents production time, and the ordinate represents test result.

In S203, the electronic device determines a sample segment point of each sample according to values of the device parameter, so as to obtain N value groups of target values corresponding to each sample. The sample segment point of each sample is used to represent an abrupt change point of the values of the device parameter of each sample. The target values includes values, a time difference between adjacent two acquisition times of which is less than a first threshold, in the values of the device parameter, and N is a positive integer greater than or equal to 1.

For the specific description, reference may be made to the description of S102, and details will not be repeated here.

In S204, the electronic device determines a related quantized value according to a difference between an M-th value group of a positive sample and an M-th value group of a negative sample. The related quantized value is used to represent a degree of influence of the device parameter on a defective sample, and M is a positive integer less than or equal to N.

For the specific description, reference may be made to the description of S103, and details will not be repeated here.

In S205, the electronic device displays the related quantized value on an analysis result display interface.

Optionally, the electronic device sorts related quantized values according to magnitudes thereof, and the electronic device displays a sorting of value groups of the device parameter corresponding to the related quantized values on the analysis result display interface.

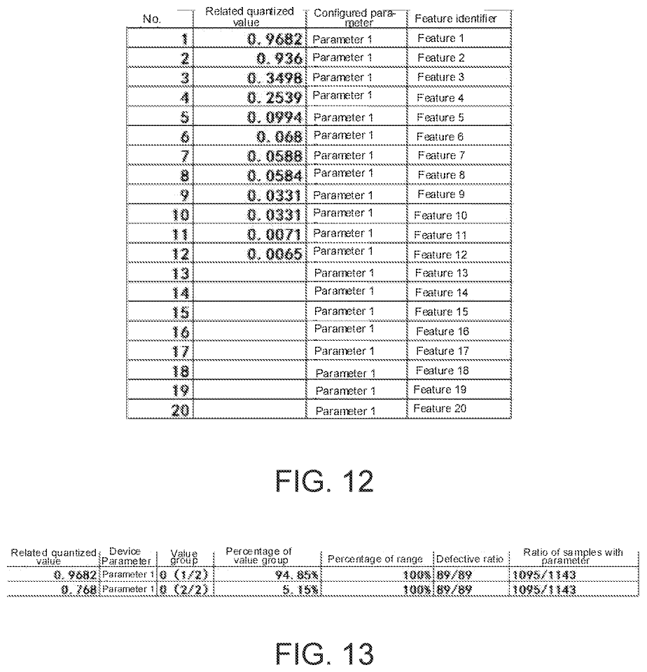

In an example, as shown in FIG. 12, the electronic device displays each of the value groups corresponding to the related quantized values on the analysis result display interface. The electronic device sorts a plurality of related quantized values of a value group from high to low in units of value groups. In FIG. 12, device parameter 1 is ranked first, and only corresponds to one process step and one value group. Related quantized values of 20 statistical indices of device parameter 1 are sorted from high to low. As a result, a related quantized value of feature 1 is the highest, which is 0.9682.

Optionally, the electronic device acquires an output parameter, which includes at least one of an information parameter of a value group, a percentage of range, a first ratio or a second ratio. The first ratio is a ratio of the number of samples corresponding to the device parameter to the total number of the plurality of samples. The second ratio is a ratio of the number of defective samples corresponding to the device parameter to the total number of the negative samples. The electronic device displays the output parameter on the analysis result display interface. The information parameter includes a position of the value group in the value groups of the device parameter, or a percentage of the value group in the target values, or the position of the value group in the value groups of the device parameter and the percentage of the value group in the target values.

For example, the obtained related quantized values of each value group displayed by the electronic device on the analysis result display interface are shown in FIG. 13. In FIG. 13, there are related quantized values of two value groups of device parameter 1. In FIG. 13, a maximum value of related quantized values of a value group in a first row is 0.9682, and a name of a device parameter corresponding to the value group is parameter 1; the value group 0(½) indicates that there is only one recipe step during production of the samples, and the recipe step is divided into 2 value groups, and the value group 0(½) is a first value group; a percentage of the value group is 94.85%, which indicates a percentage of the value group in the entire recipe step; a percentage of range is 100.0%, which indicates a percentage of a range (a difference of a maximum value and a minimum value) of the recipe step in a range of the entire process; a defective ratio is (89/89), which indicates a ratio of the number of reported defective samples with the device parameter to the number of all defective samples; a ratio of samples with the parameter is (1095/1143), which indicates a ratio of the number of reported samples with the device parameter to the number of all samples.

The foregoing mainly describes the solutions provided in the embodiments of the present disclosure from a method perspective. In order to achieve the above functions, corresponding hardware structures and/or software modules for performing various functions are included herein. A person skilled in the art will easily realize that, in combination with units and algorithm steps of the examples described in the embodiments disclosed herein, the present disclosure may be implemented by hardware or a combination of hardware and computer software. Whether a certain function is implemented by hardware or in a way of driving hardware by computer software depends on specific applications and design constraints of the technical solution. A skilled person may implement the described functions in different ways for each specific application, but such implementation should not be considered beyond the scope of the present disclosure.

Functional modules of the electronic device in the above embodiments may be divided based on the above method examples. For example, the functional modules may be divided according to functions thereof, or two or more functions may be integrated into one processing module. The above integrated modules may be implemented in the form of hardware or software functional modules. It will be noted that, the division of the modules in the embodiments of the present disclosure is schematic, and is only a logical function division, and there may be other manners to divide the functional modules in actual implementation.

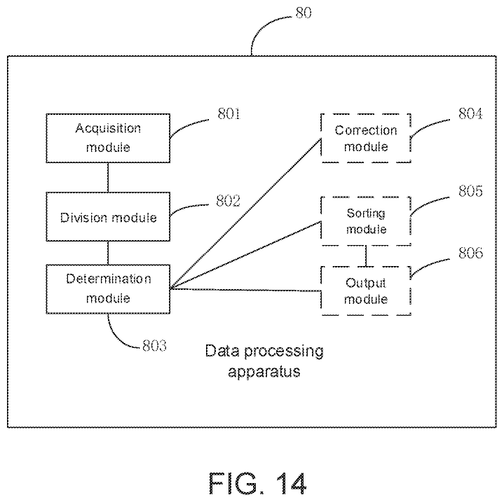

FIG. 14 is a diagram showing a structure of a data processing apparatus 80 provided in embodiments of the present disclosure. The data processing apparatus 80 includes an acquisition module 801, a division module 802 and a determination module 803. The acquisition module 801 is used to acquire sample data of each sample of a plurality of samples produced within a preset time period. The sample data includes a value, which is acquired at each acquisition time, of a device parameter of a device through which the sample passes, and a test result of the sample. The division module 802 is used to divide sample data of the samples into data of positive samples and data of negative samples according to test results of the samples. The determination module 803 is used to determine a sample segment point of each sample according to values of the device parameter, so as to obtain N value groups of target values corresponding to each sample. The sample segment point of each sample is used to represent an abrupt change point of the values of the device parameter of each sample. The target values includes values, a time difference between adjacent two acquisition times of which is less than a first threshold, in the values of the device parameter, and N is a positive integer greater than or equal to 1. The determination module 803 is further used to determine a related quantized value according to a difference between an M-th value group of a positive sample and an M-th value group of a negative sample. The related quantized value is used to represent a degree of influence of the device parameter on a defective sample, and M is a positive integer less than or equal to N. For example, with reference to FIG. 3, the acquisition module 801 may be used to perform S100, the division module 802 may be used to perform S101, and the determination module 803 may be used to perform S102 and S103.

In some embodiments, the determination module 803 is used to determine a first value of statistical indices of the M-th value group of the negative sample and a second value of statistical indices of the M-th value group of the positive sample. The statistical indices of each value group are used to represent a centralized trend or a variation trend of the values in the value group. The determination module 803 is further used to determine a difference between the first value and the second value, and determine the related quantized value according to the difference.

In some other embodiments, the determination module 803 is used to determine the difference between the first value and the second value according to a feature parameter of a plurality of first values of the negative sample and a feature parameter of a plurality of second values of the positive sample.

In yet some other embodiments, the feature parameter includes a value at a target position, or a population mean value, or the value at the target position and the population mean value.

In yet some other embodiments, the determination module 803 is used to: determine a first difference between a value at a target position in the plurality of first values of the negative sample and a value at the target position in the plurality of second values of the positive sample; determine a second difference between a population mean value of the plurality of first values of the negative sample and a population mean value of the plurality of second values of the positive sample; and determine the difference between the first value and the second value according to the first difference, the second difference and the preset weight.

In yet some other embodiments, the determination module 803 is used to: determine sample data of a reference sample according to the values of the device parameter, the reference sample being a sample in the positive samples; determine a signal-to-noise ratio of the reference sample, and an absolute value of the signal-to-noise ratio being as a signal-to-noise ratio absolute value; take a value, an absolute value of which is greater than the signal-to-noise ratio absolute value, in filtered values of the device parameter, as a reference sample segment point; and determine the sample segment point of each sample according to a reference ratio and the reference sample segment point, so as to obtain the N value groups of the target values corresponding to each sample, the reference ratio being a ratio of the number of values of the device parameter of the reference sample to the number of the values of the device parameter of each sample.

In yet some other embodiments, the determination module 803 is used to determine an initial sample segment point of each sample according to the reference ratio and the reference sample segment point. The acquisition module is further used to acquire, according to the determined initial sample segment point and a size of a preset window, a correlation between value groups of the device parameter, in which one value group is at a distance within a size range of the preset window from the initial sample segment point, and the other value group is at a distance within the size range of the preset window from the reference sample segment point. The data processing apparatus further includes a correction module 804, which is used to correct the initial sample segment point of each sample according to the correlation.

In yet some other embodiments, the determination module 803 is further used to: perform Fourier transform on values of the device parameter of each of the positive samples; take a minimum number of transformed values of the device parameter of the positive samples as a trimming number; acquire front values, the number of which is the trimming number, in the values of the device parameter of each of the positive samples, so as to obtain a plurality of trimming value groups, the number of values included in each trimming value group being the trimming number; acquire, according to an order of values in each trimming value group, a median of values at each position in the plurality of trimming value groups, so as to obtain a median sequence; and determine the sample data of the reference sample in the positive samples, the reference sample being a sample with a minimum difference value with the median sequence in the positive samples.

In yet some other embodiments, the acquisition module 801 is used to: acquire initial sample data of each sample produced within the preset time period; acquire the numbers of target values of the positive samples in initial sample data of the samples; determine a value range according to the numbers of the target values of the positive samples; and filter initial data of a positive sample, the number of target values of which is outside the value range, in the initial sample data of the samples produced within the preset time period, so as to obtain the sample data of each sample of the plurality of samples produced within the preset time period.

The acquisition module 801 is used to: acquire the initial sample data of each sample produced within the preset time period; determine a trimming length according to at least a median of the numbers of target values of the initial sample data of the samples; and trim the acquired initial sample data of each sample according to the trimming length, so as to obtain the sample data of each sample in the plurality of samples produced within the preset time period.

In yet some other embodiments, the data processing apparatus 80 further includes a sorting module 805 for sorting related quantized values according to magnitudes thereof, and an output module 806 for outputting a sorting of value groups of the device parameter corresponding to the related quantized values.

In yet some other embodiments, the output module 806 is further used to output an information parameter of a value group of the device parameter. The information parameter includes a position of the value group in the value groups of the device parameter, or a percentage of the value group in the target values, or the position of the value group in the value groups of the device parameter and the percentage of the value group in the target values.

In an example, referring to FIG. 2, the receiving function of the acquisition module 801 may be implemented by the interface unit 304 in FIG. 2. The processing function of the acquisition module 801, the division module 802, the determination module 803, the correction module 804, the sorting module 805 and the output module 806 may all be implemented by the processor 301 in FIG. 2 calling the computer programs stored in the memory 302.

For specific descriptions of the above optional manners, reference may be made to the foregoing method embodiments, and details will not be repeated here. In addition, for explanation and description of beneficial effects of the data processing apparatus 80 in any application example provided above, reference may be made to the corresponding method embodiments described above, and details will not be repeated here.

It will be noted that, operations correspondingly performed by the above modules are only specific examples, and for operations actually performed by various modules, reference may be made to the operations or steps mentioned in the above description of the embodiments based on FIG. 3.

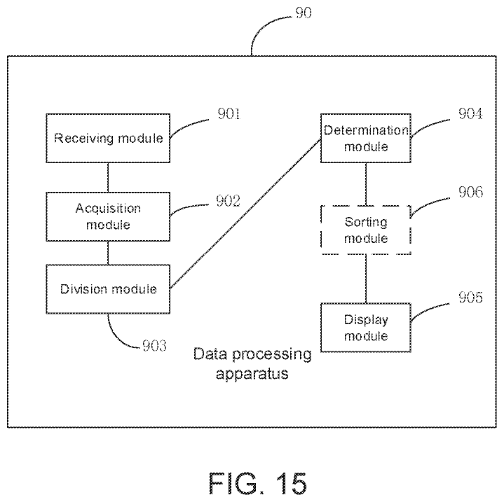

FIG. 15 is a diagram showing a structure of a data processing apparatus 90 provided in embodiments of the present disclosure. The data processing apparatus 90 includes a receiving module 901, an acquisition module 902, a division module 903, a determination module 904 and a display module 905. The receiving module 901 is used to receive the sample screening conditions of the input of the user on the condition selection interface. The acquisition module 902 is used to acquire sample data of each sample of a plurality of samples corresponding to sample screening conditions. The sample data includes a value, which is acquired at each acquisition time, of a device parameter of a device through which the sample passes, and a test result of the sample. The division module 903 is used to divide sample data of the samples into data of positive samples and data of negative samples according to test results of the samples. The determination module 904 is used to determine a sample segment point of each sample according to values of the device parameter, so as to obtain N value groups of target values corresponding to each sample. The sample segment point of each sample is used to represent an abrupt change point of the values of the device parameter of each sample. The target values includes values, a time difference between the adjacent two acquisition times of which is less than a first threshold, in the values of the device parameter, and N is a positive integer greater than or equal to 1. The determination module 904 is further used to determine a related quantized value according to a difference between an M-th value group of a positive sample and an M-th value group of a negative sample. The related quantized value is used to represent a degree of influence of the device parameter on a defective sample, and M is a positive integer less than or equal to N. The display module 905 is used to display the related quantized value on the analysis result display interface. For example, with reference to FIG. 7, the receiving module 901 may be used to perform S200, the acquisition module 902 may be used to perform S201, the division module 903 may be used to perform S202, the determination module 904 may be used to perform S203 and S204, and the display module 905 may be used to perform S205.

In some other embodiments, the data processing apparatus further includes a sorting module 906 for sorting related quantized values according to magnitudes thereof. The display module 905 is used to display a sorting of value groups of the device parameter corresponding to the related quantized values on the analysis result display interface.

In yet some other embodiments, the display module 905 is further used to display an information parameter of a value group of the device parameter on the analysis result display interface. The information parameter includes a position of the value group in the value groups of the device parameter, or a percentage of the value group in the target values, or the position of the value group in the value groups of the device parameter and the percentage of the value group in the target values.

In an example, referring to FIG. 2, the receiving functions of the receiving module 901 and the acquisition module 902 may be implemented by the interface unit 304 in FIG. 2. The processing function of the acquisition module 902, the division module 903, the determination module 904, the display module 905 and the sorting module 906 may all be implemented by the processor 301 in FIG. 2 calling the computer programs stored in the memory 302.

For specific descriptions of the above optional manners, reference may be made to the foregoing method embodiments, and details will not be repeated here. In addition, for explanation and description of beneficial effects of the data processing apparatus 90 in any application example provided above, reference may be made to the corresponding method embodiments described above, and details will not be repeated here.

It will be noted that, operations correspondingly performed by the above modules are only specific examples, and for operations actually performed by various modules, reference may be made to the operations or steps mentioned in the above description of the embodiments based on FIG. 7.

Some embodiments of the present disclosure provide an electronic device. The electronic device includes a processor and a memory for storing instructions executed by the processor. The processor is configured to execute the instructions to perform the data processing method as described in any one of the above embodiments.

Some embodiments of the present disclosure provide a computer-readable storage medium (e.g., a non-transitory computer-readable storage medium). The computer-readable storage medium has stored thereon computer program instructions that, when run on a processor, cause the processor to execute one or more steps of the data processing method as described in any one of the above embodiments.

For example, the computer-readable storage medium may include, but is not limited to, a magnetic storage device (e.g., a hard disk, a floppy disk or a magnetic tape), an optical disk (e.g., a compact disk (CD)), a digital versatile disk (DVD), a smart card, or a flash memory device (e.g., an erasable programmable read-only memory (EPROM), a card, a stick or a key driver). Various computer-readable storage media described in the present disclosure may represent one or more devices and/or other machine-readable storage media, which are used to store information. The term “machine-readable storage media” may include, but is not limited to, wireless channels and various other media capable of storing, containing and/or carrying instructions and/or data.

Some embodiments of the present disclosure provide a computer program product. The computer program product includes computer program instructions that, when run on a computer, cause the computer to execute one or more steps of the data processing method as described in any one of the above embodiments.

Some embodiments of the present disclosure provide a computer program. When the computer program is run on a computer, the computer program causes the computer to execute one or more steps of the data processing method as described in any one of the above embodiments.

Beneficial effects of the computer-readable storage medium, the computer program product and the computer program are same as beneficial effects of the data processing method as described in some embodiments described above, and details will not be repeated herein.

The foregoing descriptions are merely specific implementations of the present disclosure, but the protection scope of the present disclosure is not limited thereto. Any changes or replacements that a person skilled in the art could readily conceive of within the technical scope of the present disclosure shall be included in the protection scope of the present disclosure. Therefore, the protection scope of the present disclosure shall be subject to the protection scope of the claims.

1. A data processing method, comprising:
acquiring sample data of each sample of a plurality of samples produced within a preset time period, the sample data including a value, which is acquired in each acquisition time, of a device parameter of a device through which the sample passes, and a test result of the sample;
dividing sample data of the plurality of samples into data of positive samples and data of negative samples according to test results of the plurality of samples;
determining a sample segment point of each sample according to values of the device parameter, so as to obtain N value groups of target values corresponding to each sample, the sample segment point of each sample being used to represent an abrupt change point of the values of the device parameter of each sample, and the target values including values, a time difference between adjacent two acquisition times of which is less than a first threshold, in the values of the device parameter, and N being a positive integer greater than or equal to 1; and
determining a related quantized value according to a difference between an M-th value group of a positive sample and an M-th value group of a negative sample, the related quantized value being used to represent a degree of influence of the device parameter on a defective sample, and M being a positive integer less than or equal to N.

2. The data processing method according to claim 1, wherein determining the related quantized value according to the difference between the M-th value group of the positive sample and the M-th value group of the negative sample includes:
determining a first value of statistical indices of the M-th value group of the negative sample and a second value of statistical indices of the M-th value group of the positive sample, statistical indices of each value group being used to represent a centralized trend or a variation trend of values in the value group;
determining a difference between the first value and the second value; and
determining the related quantized value according to the difference between the first value and the second value.

3. The data processing method according to claim 2, wherein determining the difference between the first value and the second value includes:
determining the difference between the first value and the second value according to a feature parameter of a plurality of first values of the negative sample and a feature parameter of a plurality of second values of the positive sample.

4. The data processing method according to claim 3, wherein the feature parameter includes a value at a target position, or a population mean value, or the value at the target position and the population mean value.

5. The data processing method according to claim 3, wherein determining the difference between the first value and the second value according to the feature parameter of the plurality of first values of the negative sample and the feature parameter of the plurality of second values of the positive sample includes:
determining a first difference between a value at a target position in the plurality of first values of the negative sample and a value at the target position in the plurality of second values of the positive sample;
determining a second difference between a population mean value of the plurality of first values of the negative sample and a population mean value of the plurality of second values of the positive sample; and
determining the difference between the first value and the second value according to the first difference, the second difference and a preset weight.

6. The data processing method according to claim 1, wherein determining the sample segment point of each sample according to the values of the device parameter, so as to obtain the N value groups of the target values corresponding to each sample includes:
determining sample data of a reference sample according to the values of the device parameter, the reference sample being a sample in the positive samples;
determining a signal-to-noise ratio of the reference sample, an absolute value of the signal-to-noise ratio being a signal-to-noise ratio absolute value;
taking a value, an absolute value of which is greater than the signal-to-noise ratio absolute value, in filtered values of the device parameter, as a reference sample segment point; and
determining the sample segment point of each sample according to a reference ratio and the reference sample segment point, so as to obtain the N value groups of the target values corresponding to each sample, the reference ratio being a ratio of a number of values of the device parameter of the reference sample to a number of the values of the device parameter of each sample.

7. The data processing method according to claim 6, wherein
determining the sample segment point of each sample according to the reference ratio and the reference sample segment point includes:
determining an initial sample segment point of each sample according to the reference ratio and the reference sample segment point;
acquiring, according to the determined initial sample segment point and a size of a preset window, a correlation between value groups of the device parameter, in which one value group is at a distance within a size range of the preset window from the initial sample segment point, and another value group is at a distance within the size range of the preset window from the reference sample segment point; and
correcting the initial sample segment point of each sample according to the correlation.

8. The data processing method according to claim 6, wherein determining the sample data of the reference sample according to the values of the device parameter includes:
performing Fourier transform on values of the device parameter of each of the positive samples;
taking a minimum number of transformed values of the device parameter of the positive samples as a trimming number;
acquiring front values, a number of which is the trimming number, in the values of the device parameter of each of the positive samples, so as to obtain a plurality of trimming value groups, a number of values included in each trimming value group being the trimming number;
acquiring, according to an order of the values in each trimming value group, a median of values at each position in the plurality of trimming value groups, so as to obtain a median sequence; and
determining the sample data of the reference sample in the data of the positive samples, the reference sample being a sample with a minimum difference value with the median sequence in the positive samples.

9. The data processing method according to claim 1, wherein acquiring the sample data of each sample of the plurality of samples produced within the preset time period includes:
acquiring initial sample data of each sample produced within the preset time period; acquiring numbers of target values of the positive samples in initial sample data of the plurality of samples; determining a value range according to the numbers of the target values of the positive samples; and filtering initial data of a positive sample, a number of target values of which is outside the value range, in the initial sample data of the plurality of samples produced within the preset time period, so as to obtain the sample data of each sample of the plurality of samples produced within the preset time period; or
acquiring the initial sample data of each sample produced within the preset time period; determining a trimming length according to at least a median of numbers of target values of the initial sample data of the plurality of samples; and trimming the acquired initial sample data of each sample according to the trimming length, so as to obtain the sample data of each sample of the plurality of samples produced within the preset time period.

10. The data processing method according to claim 1, further comprising:
sorting related quantized values according to magnitudes thereof; and
outputting a sorting of value groups of the device parameter corresponding to the related quantized values.

11. The data processing method according to claim 1, further comprising:
outputting an information parameter of a value group of the device parameter, the information parameter including a position of the value group in value groups of the device parameter, or a percentage of the value group in the target values, or the percentage of the value group in the target values and the percentage of the value group in the target values.

12. A data processing method, comprising:
receiving sample screening conditions of an input on a condition selection interface;
acquiring sample data of each sample of a plurality of samples corresponding to the sample screening conditions, the sample data including a value, which is acquired at each acquisition time, of a device parameter of a device through which the sample passes, and a test result of the sample;
dividing sample data of the plurality of samples into data of positive samples and data of negative samples according to test results of the plurality of samples;
determining a sample segment point of each sample according to values of the device parameter, so as to obtain N value groups of target values corresponding to each sample, the sample segment point of each sample being used to represent an abrupt change point of the values of the device parameter of each sample, and the target values including values, a time difference between adjacent two acquisition times of which is less than a first threshold, in the values of the device parameter, and N being a positive integer greater than or equal to 1;
determining a related quantized value according to a difference between an M-th value group of a positive sample and an M-th value group of a negative sample, the related quantized value being used to represent a degree of influence of the device parameter on a defective sample, and M being a positive integer less than or equal to N; and
displaying the related quantized value on an analysis result display interface.

13. The data processing method according to claim 12, further comprising:
sorting related quantized values according to magnitudes thereof; wherein
displaying the related quantized value on the analysis result display interface includes:
displaying a sorting of value groups of the device parameter corresponding to the related quantized values on the analysis result display interface.

14. The data processing method according to claim 12, further comprising:
displaying an information parameter of a value group of the device parameter on the analysis result display interface, the information parameter including a position of the value group in value groups of the device parameter, or a percentage of the value group in the target values, or the position of the value group in value groups of the device parameter and the percentage of the value group in the target values.

15-17. (canceled)

18. An electronic device, comprising:
a processor, and
a memory for storing instructions executed by the processor, the processor being configured to execute the instructions to perform the data processing method according to claim 1.

19. A non-transitory computer-readable storage medium having stored thereon instructions that, when run on a processor, cause the processor to execute the data processing method according to claim 1.

20. (canceled)

21. The data processing method according to claim 1, wherein acquiring the sample data of each sample of the plurality of samples produced within the preset time period includes:
acquiring initial sample data of each sample produced within the preset time period;
acquiring numbers of target values of the positive samples in initial sample data of the plurality of samples;
determining a value range according to the numbers of the target values of the positive samples;
determining a trimming length according to at least a median of numbers of target values of initial sample data of the plurality of samples; and
filtering initial data of a positive sample, a number of target values of which is outside the value range, in the initial sample data of the plurality of samples produced within the preset time period, and trimming the acquired initial sample data of each sample according to the trimming length, so as to obtain the sample data of each sample of the plurality of samples produced within the preset time period.

22. An electronic device, comprising:
a memory for storing instructions; and
a processor configured to execute the instructions to perform the data processing method according to claim 12.

23. A non-transitory computer-readable storage medium having stored thereon instructions that, when run on a processor, cause the processor to execute the data processing method according to claim 12.

24. An electronic device, comprising:
a memory for storing instructions; and
a processor configured to execute the instructions to perform a data processing method, wherein
the data processing method includes:
acquiring sample data of each sample of a plurality of samples produced within a preset time period, the sample data including a value, which is acquired in each acquisition time, of a device parameter of a device through which the sample passes, and a test result of the sample;
dividing sample data of the plurality of samples into data of positive samples and data of negative samples according to test results of the plurality of samples;
determining a sample segment point of each sample according to values of the device parameter, so as to obtain N value groups of target values corresponding to each sample, the sample segment point of each sample being used to represent an abrupt change point of the values of the device parameter of each sample, and the target values including values, a time difference between adjacent two acquisition times of which is less than a first threshold, in the values of the device parameter, and N being a positive integer greater than or equal to 1; and
determining a related quantized value according to a difference between an M-th value group of a positive sample and an M-th value group of a negative sample, the related quantized value being used to represent a degree of influence of the device parameter on a defective sample, and M being a positive integer less than or equal to N.
